(19) United States
(12) Patent Application Publication
(10) Pub. No.: US 2026/0136024 A1
(43) Pub. Date: May 14, 2026

(54) Filter Coefficient Derivation Simplification For Cross-Component Prediction

(71) Applicant: Google LLC, Mountain View, CA (US)

(72) Inventors: Xiang Li, Saratoga, CA (US); Jingning Han, Santa Clara, CA (US); Yaowu Xu, Saratoga, CA (US); Debargha Mukherjee, Cupertino, CA (US)

(21) Appl. No.: 19/120,066

(22) PCT Filed: Dec. 16, 2022
(86) PCT No.: PCT/US2022/053149

§ 371 Date: Apr. 10, 2025

Related U.S. Application Data
(60) Provisional application No. 63/415,952, filed on Oct. 13, 2022.

(51) Int. Cl. H04N 19/196; H04N 19/117; H04N 19/159; H04N 19/82

(52) U.S. Cl. CPC H04N 19/196; H04N 19/117; H04N 19/159; H04N 19/82

(57) ABSTRACT

Filter coefficient derivation simplification for cross-component prediction reduces latencies typically introduced by convolutional cross-component model (CCCM) prediction and thus enables use of CCCM prediction by hardware coders. Various approaches for filter coefficient derivation simplification are disclosed, including limiting a dynamic range of filter coefficient derivation to a defined bit range, limiting filter coefficient derivation and thus use of CCCM prediction based on coding unit size, and/or enabling filter coefficient derivation directly from non-downsampled luma samples.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

Disclosed herein are, inter alia, systems and techniques for filter coefficient derivation simplification for cross-component prediction.

A method for filter coefficient derivation simplification for cross-component prediction according to an implementation of this disclosure comprises determining filter coefficients for a current coding unit based on samples within a reference area for the current coding unit, reducing a bit precision of the filter coefficients to produce reduced filter coefficients, determining a predicted chroma sample for a current luma sample based on input values for the current luma sample and based on the reduced filter coefficients, and encoding or decoding the predicted chroma sample.

In some implementations of the method, reducing the bit precision of the filter coefficients to produce the reduced filter coefficients comprises reducing a number of bits used to store values of the filter coefficients from a first number of bits to a second number of bits, wherein values of the reduced filter coefficients are stored using the second number of bits.

In some implementations of the method, the values of the reduced filter coefficients are clipped using one or more threshold values.

In some implementations of the method, the method comprises clipping the reduced filter coefficients according to a minimum clipping value and a maximum clipping value.

In some implementations of the method, a filter coefficient corresponding to a bias term is determined after all other filter coefficients are determined.

In some implementations of the method, the filter coefficients are determined based on non-downsampled luma samples of the reference area.

In some implementations of the method, the filter coefficients are determined based on the current coding unit having a size greater than a threshold.

In some implementations of the method, a number of the filter coefficients is limited when a size of the current coding unit is less than a threshold.

In some implementations of the method, the threshold corresponds to an 8×8 chroma sample unit.

In some implementations of the method, a first number of the filter coefficients is determined based on the current coding unit having a size greater than a threshold and a second number of the filter coefficients smaller than the first number is determined based on the current coding unit having a size lesser than the threshold.

In some implementations of the method, determining the filter coefficients comprises deriving at least a portion of the filter coefficients based on reconstructed chroma samples within the reference area.

In some implementations of the method, determining the filter coefficients comprises decoding one or more syntax elements associated with the filter coefficients signaled within a bitstream.

In some implementations of the method, the predicted chroma sample is clipped using one or more threshold values and based on chroma values in the reference area.

In some implementations of the method, the method comprises clipping the predicted chroma sample according to a minimum clipping value, a maximum clipping value, and a weighting factor.

An apparatus for filter coefficient derivation simplification for cross-component prediction according to an implementation of this disclosure comprises a memory and a processor configured to execute instructions stored in the memory to obtain samples within a reference area for a current coding unit, reduce a bit precision of filter coefficients determined based on the samples to produce reduced filter coefficients, determine input values for a current luma sample, determine a predicted chroma sample for the current luma sample based on the input values and the reduced filter coefficients, and encode or decode the predicted chroma sample.

In some implementations of the apparatus, the processor is configured to execute the instructions to clip the reduced filter coefficients according to a minimum clipping value and a maximum clipping value.

In some implementations of the apparatus, the processor is configured to execute the instructions to clip the predicted chroma sample based on chroma values in the reference area.

In some implementations of the apparatus, when an auto-correlation matrix computed in connection with the determination of the filter coefficients is singular, an average of reconstructed chroma values in the reference area is used as the predicted chroma sample.

A non-transitory computer-readable storage device according to an implementation of this disclosure includes program instructions executable by one or more processors that, when executed, cause the one or more processors to perform operations for filter coefficient derivation simplification for cross-component prediction, in which the operations comprise reducing a bit precision of filter coefficients determined for a current coding unit to produce reduced filter coefficients, determining input values for a current luma sample, determining a predicted chroma sample for the current luma sample based on the input values and the reduced filter coefficients, and encoding or decoding the predicted chroma sample.

In some implementations of the non-transitory computer-readable storage device, the reduced filter coefficients are clipped according to a minimum value and a maximum value, and the predicted chroma sample is clipped based on chroma values in a reference area that includes samples used to determine the filter coefficients.

These and other aspects of this disclosure are disclosed in the following detailed description of the implementations, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and decoded.

FIG. 4 is a block diagram of an example of an encoder.

FIG. 5 is a block diagram of an example of a decoder.

FIG. 6 is an illustration of examples of portions of a video frame.

FIG. 7 illustrates an example of a reference area for cross-component prediction.

FIG. 8 illustrates an example of a neighborhood of a luma sample used to predict a chroma sample.

FIG. 9 illustrates example resolutions of luma and chroma blocks.

FIG. 10 illustrates an example reference area used for deriving cross-component prediction filter coefficients directly from non-downsampled luma samples.

FIG. 11 is a flowchart diagram of an example of a technique for filter coefficient derivation simplification for cross-component prediction.

### DETAILED DESCRIPTION

Video compression schemes may include breaking respective images, or frames, of a video stream into smaller portions, such as blocks, or coding tree units (CTUs), and generating an encoded bitstream using techniques to limit the information included for respective CTUs thereof. The bitstream can be decoded to re-create the source frames from the limited information. Encoding CTUs to or decoding CTUs from a bitstream can include predicting the values of pixels or CTUs based on similarities with other pixels or CTUs in the same frame which have already been coded. Those similarities can be determined using intra prediction, which attempts to predict the pixel values of a coding unit (CU) of a CTU using pixels peripheral to the CU (e.g., pixels that are in the same frame as the CU, but which are outside the CU). During encoding, the result of an intra-prediction mode performed against a CU is a prediction unit (PU). A prediction residual can be determined based on a difference between the pixel values of the CU and the pixel values of the PU. The prediction residual and the intra prediction mode used to ultimately obtain that prediction residual can then be encoded to a bitstream. During decoding, the prediction residual is reconstructed into a CU using a PU produced based on the intra prediction mode and is thereafter included in an output video stream.

A CU includes a luminance, also referred to as luma, component and two chrominance, also referred to as chroma, components. These luma and chroma components may in some case be referred to as a luma block and chroma blocks. The luma component of a CU may, for example, be expressed within a Y plane of the CU and the chroma components may be expressed either within U and V planes or Cr and Cb planes of the CU. The luma component is understood to include some number of luma samples and each chroma component is understood to include some number of chroma samples. Generally, the luma samples provide measures of brightness throughout a subject CU and thus represents the structural qualities of the video content of the subject CU, whereas the chroma samples provide measures of color throughout the subject CU. Because of this, conventional video compression schemes often use finer prediction approaches for predicting luma components of CUs than chroma components thereof. Such schemes may also use approaches directed to predicting those chroma components from the predicted luma components.

One example of such a chroma from luma prediction approach is cross-component linear model (CCLM) prediction as proposed for use with the H.266 codec, also referred to as Versatile Video Coding (VVC), which is used in intra-predicted CUs to predict a chroma signal based on a weighted luma signal. With CCLM prediction, chroma samples of a CU are predicted based on the reconstructed luma samples of the same CU by using a linear model represented as pred_C (i, j)=α*rec_L′ (i, j)+β, in which pred_C (i, j) represents the predicted chroma samples in a CU and rec_L′ (i, j) represents the downsampled reconstructed luma samples of the same CU. The CCLM prediction parameters a and B are weights derived, using one or more lookup tables, from at most four neighboring chroma samples and their corresponding downsampled luma samples. The downsampling is to align the resolutions of the luma and chroma components of the CU. In particular, where the resolutions of the luma and chroma components are already equal (e.g., 4:4:4), downsampling operations may be omitted; however, where the resolutions of the luma and chroma components are not equal (e.g., 4:2:0), such that the chroma components are generally smaller than the luma component, one or more downsampling filters may be applied to the luma samples within the luma component in both horizontal and vertical directions. Examples of the downsampling filters may include Type-0, in which each chroma sample exists between two vertical luma samples throughout the CU, and Type-2, in which a chroma sample exists for each luma sample throughout the CU. Due to the high correlation between luma and chroma values, CCLM prediction is generally more efficient than conventional chroma spatial prediction approaches when a CU is rich in textures, especially chroma textures.

While CCLM prediction offers benefits over historical approaches for chroma from luma prediction, there may be opportunities to further improve the accuracy and/or efficiency of CCLM prediction. One such opportunity relates to a newer approach to chroma from luma prediction that builds off of CCLM prediction, referred to as convolutional cross-component model (CCCM) prediction. CCCM prediction uses a seven-tap filter including a five-tap spatial component, a one-tap non-linear term, and a one-tap bias term. The spatial component includes a current luma sample, C, and four neighbor samples referred to as N, S, E, and W (e.g., arranged in a plus, x, diamond, or other shape in which C in whichever such case is located in the middle). The non-linear term, P, is represented as a power of two of C and scaled to the sample value range of the content, represented as P=(C*C+midVal)>>bitDepth, in which bitDepth represents a bit precision for the video content and midVal is the middle chroma value within that bit precision. For example, for 10-bit video content, bitDepth would be equal to 10 and midVal would be equal to 512. The bias term, B, represents a scalar offset between the input and output, similar to the offset term in CCLM prediction, and is set to the middle chroma value for the bit precision (e.g., 512 for 10-bit video content)—thus, B is equal to midVal.

The output of CCCM prediction, a predicted chroma value based on C, is calculated as a convolution between filter coefficients cᵢ, in which the value of i is from 0 to 6, inclusive, and the input values and is clipped to the range of valid chroma samples. The predicted chroma value, predChroma Val, is represented as predChroma Val=c₀C+c₁N+c₂S+c₃E+c₄W+c₅P+c₆B. The filter coefficients cᵢ are determined by minimizing a mean squared error (MSE) between predicted and reconstructed chroma samples in a reference area corresponding to one or more CTUs including a current CTU including the CU under prediction. In one example, the reference area may include N (e.g., 6) lines of chroma samples above and to the left of the CU, and the reference area may accordingly extend by one CU width to the right and one CU height below the CU boundaries. The reference area is adjusted to include only available chroma samples. An extension to the reference area, represented as one sample surrounding the perimeter of the actual reference area, may be provided to support the chroma samples along the sides of the reference area when such side samples are otherwise unavailable. The MSE minimization is performed by calculating an autocorrelation matrix for the luma input sample and a cross-correlation vector between the luma input sample and the predicted chroma output sample.

While CCCM prediction offers many improvements over CCLM prediction alone, it is not without its drawbacks. In particular, CCCM incurs significant latency, which renders hardware coder implementations impracticable or impossible. To ensure high prediction accuracy, the filter coefficients used in CCCM prediction are 22-bit. Given that CCCM prediction requires a number of 64-bit division operations with arbitrary denominators to be sequentially performed for deriving the filter coefficients cᵢ, this derivation is very computationally expensive. There is therefore typically a long latency introduced by CCCM prediction for deriving the filter coefficients. This latency is particularly pronounced in hardware coders (i.e., combined hardware encoders and decoders or separate hardware encoders and hardware decoders), which are limited to only a certain amount of processing per cycle and which generally have a limited number of cycle budgets for small CUs. The latency imposed by CCCM prediction is further extended in scenarios where downsampling is required (e.g., for luma and chroma signals other than in the 4:4:4 format). One other drawback of current CCCM prediction approaches relates to overfitting. In particular, and as described above, the MSE minimization process performed to derive the filter coefficients for CCCM prediction uses neighboring samples. However, where those neighboring samples are very similar, the resulting matrix is singular and thus prediction values are generally unusably high or low.

Implementations of this disclosure address problems such as these using one or more filter coefficient derivation simplification approaches to CCCM prediction. The simplification approaches disclosed herein generally relate to limiting a dynamic range of filter coefficient derivation to a defined bit range, limiting filter coefficient derivation and thus use of CCCM prediction based on CU size, and/or enabling filter coefficient derivation directly from non-downsampled luma samples. The approaches directed to limiting a dynamic range of filter coefficient derivation to a defined bit range use right shifting to reduce the bit precision required for derived filter coefficients, such as from 22-bit accuracy to 6-or 8-bit accuracy. The approaches directed to limiting filter coefficient derivation based on CU size avoid unnecessary latency introduction by either preventing CCCM prediction for CUs smaller than a certain size (e.g., 8×8 chroma samples) or by limiting the number of filter coefficients which may be derived by such blocks (e.g., from seven to three). The approaches directed to enabling filter coefficient derivation directly from downsampled luma samples enable CCCM prediction operations to avoid the downsampling process in situations where the video signal is not formatted in 4:4:4, thereby avoiding latencies typically introduced by such downsampling. The filter coefficient derivation simplification approaches disclosed herein introduce meaningful limitations to the generally highly resource-intensive filter coefficient derivation process in CCCM prediction. The approaches disclosed herein thus materially reduce the latency of the coding process to enable CCCM prediction to be performed in a hardware coder.

While reference is made herein by example to CTUs, CUs, PUs, and the like, as are commonly used in video codecs such as H.265, referred to as High-Efficiency Video Coding (HEVC), and H.266, the implementations of this disclosure may be used with other video coding structures. In one particular but non-limiting example, the implementations of this disclosure may be used with superblocks, macroblocks, blocks, and the like, as are commonly used in video codecs such as VP9, AV1, and the currently in-development AV2.

Accordingly, references herein to particular video coding structures such as CTUs, CUs, PUs, and the like shall be regarded as expressions of non-limiting example video coding structures with which the implementations of this disclosure may be used.

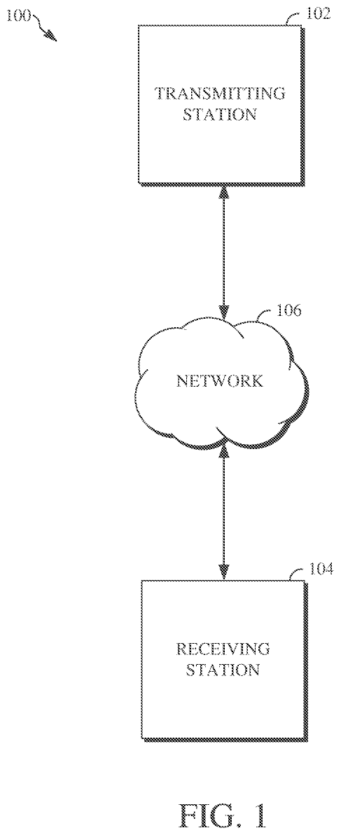

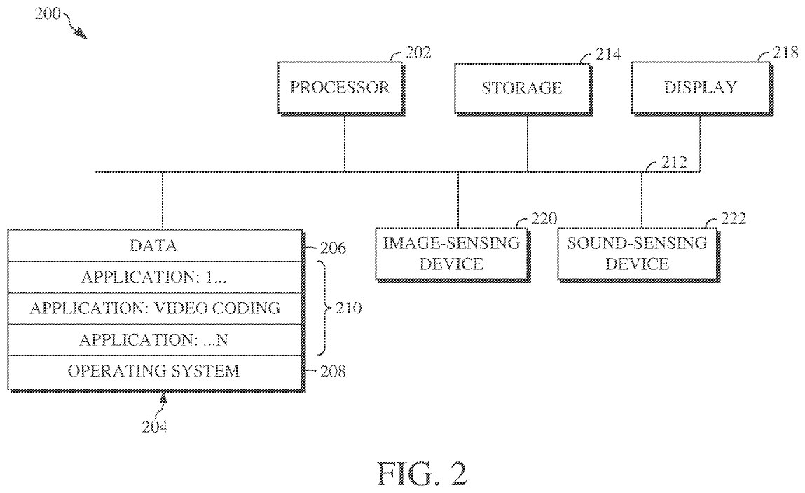

Further details of techniques for filter coefficient derivation simplification for cross-component prediction are described herein with initial reference to a system in which such techniques can be implemented. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image (e.g., a CTU of a frame of a video stream). In such an implementation, the transmitting station 102 may be used to encode the image data and the receiving station 106 may be used to decode the image data.

Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include encoding and/or decoding software that performs, amongst other things, enhanced multi-stage intra prediction as described herein.

The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200.

Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

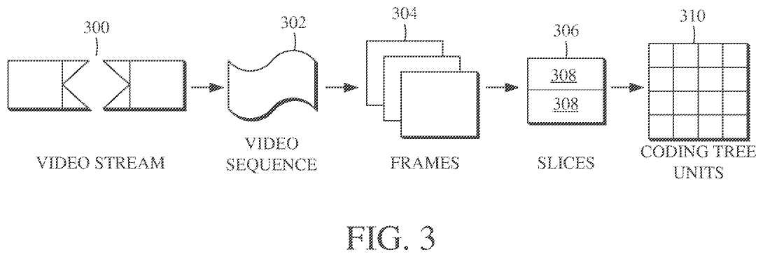

FIG. 3 is a diagram of an example of a video stream 300 to be encoded and decoded. The video stream 300 includes a video sequence 302. At the next level, the video sequence 302 includes a number of adjacent video frames 304. While three frames are depicted as the adjacent frames 304, the video sequence 302 can include any number of adjacent frames 304. The adjacent frames 304 can then be further subdivided into individual video frames, for example, a frame 306.

At the next level, the frame 306 can be divided into a series of planes, slices, or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into CTUs 310, which can contain data corresponding to, for example, N×M pixels in the frame 306, in which N and M may refer to the same integer value or to different integer values. The CTUs 310 can also be arranged to include data from one or more segments 308 of pixel data. The CTUs 310 can be of any suitable size, such as 4×4 pixels, 8×8 pixels, 16×8 pixels, 8×16 pixels, 16×16 pixels, or larger up to a maximum size, which may be 128×128 pixels or another N×M pixels size.

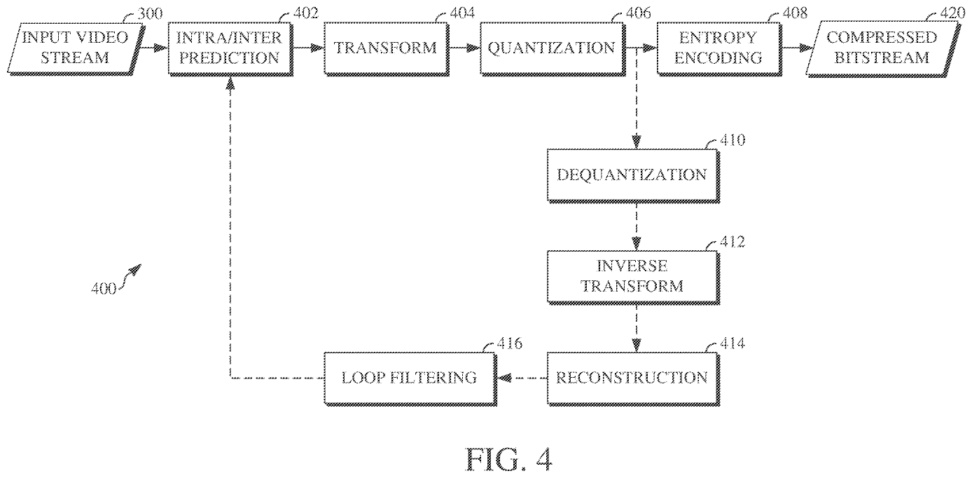

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In some implementations, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future CTUs. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

In some cases, the functions performed by the encoder 400 may occur after a filtering of the video stream 300. That is, the video stream 300 may undergo pre-processing according to one or more implementations of this disclosure prior to the encoder 400 receiving the video stream 300. Alternatively, the encoder 400 may itself perform such pre-processing against the video stream 300 prior to proceeding to perform the functions described with respect to FIG. 4, such as prior to the processing of the video stream 300 at the intra/inter prediction stage 402.

When the video stream 300 is presented for encoding after the pre-processing is performed, respective adjacent frames 304, such as the frame 306, can be processed in units of CTUs. At the intra/inter prediction stage 402, respective CUs of a CTU can be encoded using intra-frame prediction (also called intra-prediction) or inter-frame prediction (also called inter-prediction). In any case, a PU can be formed. In the case of intra-prediction, a PU may be formed from samples in the current frame that have been previously encoded and reconstructed. In the case of inter-prediction, a PU may be formed from samples in one or more previously constructed reference frames.

Next, the PU can be subtracted from the CU at the intra/inter prediction stage 402 to produce a prediction residual, also called a residual. The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the CU (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding or arithmetic coding. The compressed bitstream 420 can also be referred to as an encoded video stream or encoded video bitstream, and the terms will be used interchangeably herein.

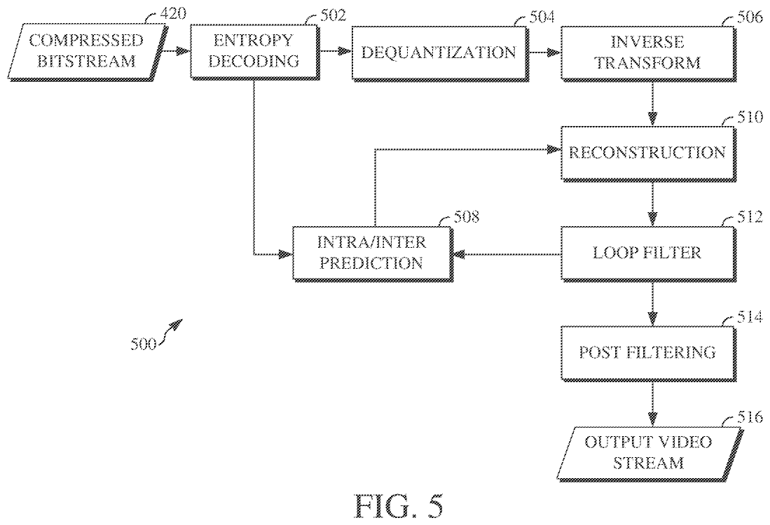

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative prediction residual (also called a derivative residual). At the reconstruction stage 414, the PU that was predicted at the intra/inter prediction stage 402 can be added to the derivative residual to create a reconstructed CU. The loop filtering stage 416 can apply an in-loop filter or other filter to the reconstructed CU to reduce distortion such as blocking artifacts. Examples of filters which may be applied at the loop filtering stage 416 include, without limitation, a deblocking filter, a directional enhancement filter, and a loop restoration filter.

Other variations of the encoder 400 can be used to encode the compressed bitstream 420. In some implementations, a non-transform based encoder can quantize the residual signal directly without the transform stage 404 for certain CUs, CTUs, or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106. In some implementations, the decoder 500 is a hardware decoder.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filter stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same PU as was created in the encoder 400 (e.g., at the intra/inter prediction stage 402).

At the reconstruction stage 510, the PU can be added to the derivative residual to create a reconstructed CU. The loop filtering stage 512 can be applied to the reconstructed CU to reduce blocking artifacts. Examples of filters which may be applied at the loop filtering stage 512 include, without limitation, a deblocking filter, a directional enhancement filter, and a loop restoration filter. Other filtering can be applied to the reconstructed CU. In this example, the post filter stage 514 is applied to the reconstructed CU to reduce blocking distortion, and the result is output as the output video stream 516. The output video stream 516 can also be referred to as a decoded video stream, and the terms will be used interchangeably herein.

Other variations of the decoder 500 can be used to decode the compressed bitstream 420. In some implementations, the decoder 500 can produce the output video stream 516 without the post filter stage 514 or otherwise omit the post filter stage 514.

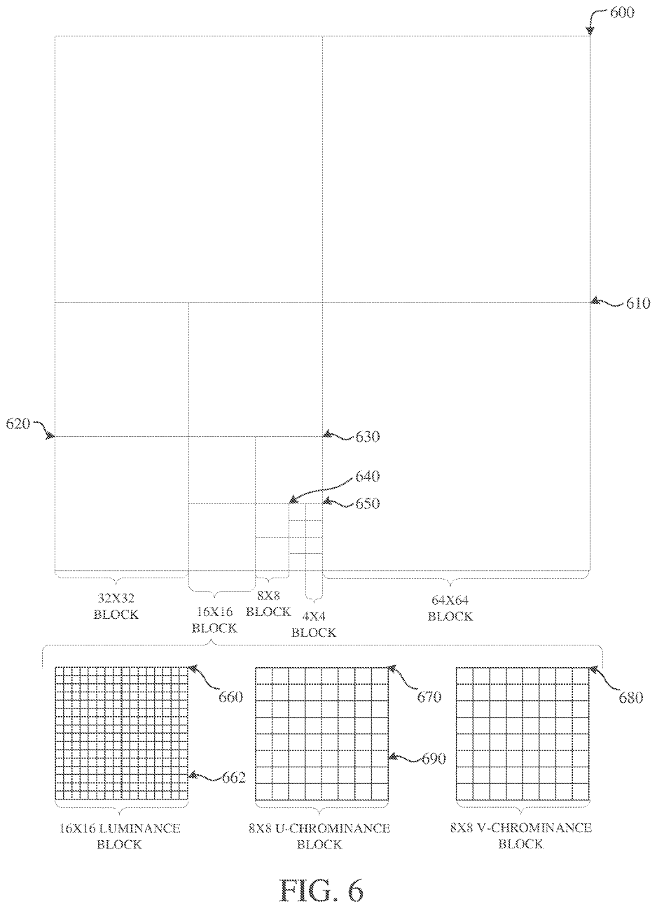

FIG. 6 is an illustration of examples of portions of a video frame 600, which may, for example, be the frame 306 shown in FIG. 3. The video frame 600 includes a number of 64×64 CTUs, such as four 64×64 CTUs 610 in two rows and two columns in a matrix or Cartesian plane, as shown. Each 64×64 CTU 610 may include up to four 32×32 CUs 620.

Each 32×2 CU 620 may include up to four 16×16 CUs 630. Each 16×16 CU 630 may include up to four 8×8 CUs 640. Each 8×8 CU 640 may include up to four 4×4 CUs 650.

Each 4×4 CU 650 may include 16 pixels, which may be represented in four rows and four columns in each respective CU in the Cartesian plane or matrix.

In some implementations, the video frame 600 may include CTUs larger than 64×64 and/or CUs smaller than 4×4. Subject to features within the video frame 600 and/or other criteria, the video frame 600 may be partitioned into various arrangements. Although one arrangement of CUs is shown, any arrangement may be used. Although FIG. 6 shows N×N CTUs and CUs, in some implementations, N×M CTUs and/or CUs may be used, wherein N and M are different numbers. For example, 32×64 CTUs, 64×32 CTUs, 16×32 CUs, 32×16 CUs, or any other size may be used. In some implementations, N×2N CTUs or CUs, 2N×N CTUs or CUs, or a combination thereof, may be used.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680.

The chrominance blocks 670, 680 may include chrominance pixels 690. For example, the luminance block 660 may include 16×16 luminance pixels 662 and each chrominance block 670, 680 may include 8×8 chrominance pixels 690 as shown.

In some implementations, coding the video frame 600 may include ordered block-level coding. Ordered block-level coding may include coding CUs of the video frame 600 in an order, such as raster-scan order, wherein CUs may be identified and processed starting with a CTU in the upper left corner of the video frame 600, or portion of the video frame 600, and proceeding along rows from left to right and from the top row to the bottom row, identifying each CU in turn for processing. For example, the 64×64 CTU in the top row and left column of the video frame 600 may be the first CTU coded and the 64×64 CTU immediately to the right of the first CTU may be the second CTU coded. The second row from the top may be the second row coded, such that the 64×64 CTU in the left column of the second row may be coded after the 64×64 CTU in the rightmost column of the first row.

In some implementations, coding a CTU of the video frame 600 may include using quad-tree coding, which may include coding smaller CUs within a CTU in raster-scan order. For example, the 64×64 CTU shown in the bottom left corner of the portion of the video frame 600 may be coded using quad-tree coding wherein the top left 32×32 CU may be coded, then the top right 32×32 CU may be coded, then the bottom left 32×32 CU may be coded, and then the bottom right 32×32 CU may be coded. Each 32×32 CU may be coded using quad-tree coding wherein the top left 16×16 CU may be coded, then the top right 16×16 CU may be coded, then the bottom left 16×16 CU may be coded, and then the bottom right 16×16 CU may be coded. Each 16×16 CU may be coded using quad-tree coding wherein the top left 8×8 CU may be coded, then the top right 8×8 CU may be coded, then the bottom left 8×8 CU may be coded, and then the bottom right 8×8 CU may be coded. Each 8×8 CU may be coded using quad-tree coding wherein the top left 4×4 CU may be coded, then the top right 4×4 CU may be coded, then the bottom left 4×4 CU may be coded, and then the bottom right 4×4 CU may be coded. In some implementations, 8×8 CUs may be omitted for a 16×16 CU, and the 16×16 CU may be coded using quad-tree coding wherein the top left 4×4 CU may be coded, then the other 4×4 CUs in the 16×16 CU may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of luma samples, and by two lower resolution chrominance components, each of which represents the portion of the image as an 8×8 block of chroma samples. A sample may indicate a value, for example, a value in the range from 0 to 255, and may be stored or transmitted using, for example, eight bits. Although this disclosure is described in reference to the YUV color model, another color model may be used. Reducing spatial redundancy may include transforming a CU into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values and/or luma and chroma samples may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

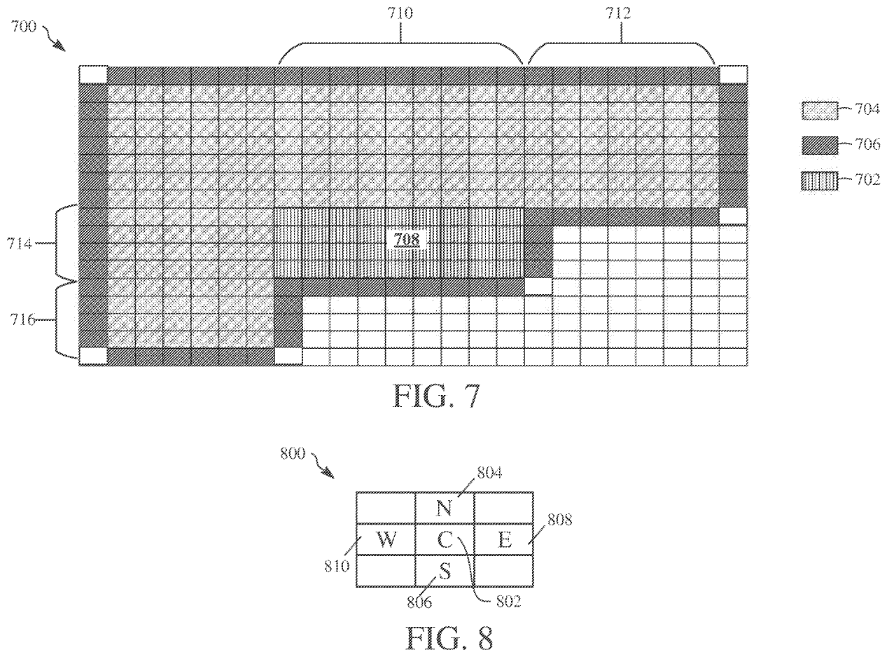

FIG. 7 illustrates an example of a reference area 700 for cross-component prediction. The reference area 700 illustrates chroma samples corresponding to multiple CUs, in which certain of those chroma samples are filled with patterns 702, 704, and 706. In particular, chroma samples filled with the pattern 702 correspond to a current PU 708 undergoing prediction, chroma samples filled with the pattern 704 are reconstructed chroma samples available for predicting chroma samples filled with the pattern 702, and chroma samples filled with the pattern 706 represent a padded area used to extend the reference area to accommodate predictions for chroma samples located along the edges of the chroma samples filled with the pattern 704. In that the chroma samples filled with the pattern 706 are not available within the current CU itself or immediately neighboring CUs, they may be understood to contain (i.e., be set to) a padding value. While the PU 708 is shown as being of size 8×4, the disclosure is not limited to particular PU sizes.

The reference area 700 may include a top region 710 that may include 1 to N (where N>1) rows of pixels. The reference area 700 may include a top-right region 712 that includes 1 to N rows. The reference area 700 may include a left region 714 of 1 to M (where M>1) columns of pixels. The reference area 700 may include a bottom-left region 716 of 1 to M (where M>1) columns of pixels. In an example, N=M. The reference area 700 may be based on the chroma color format. For example, for 4:4:4 content, the reference area 700 can also be 4-sample wide; and for 4:2:0 or 4:2:2 color formats, the reference area 700 can be 2-sample wide. In an example, when the top-right region 712 is available, only a 4×4 luma block at the top-right is included in the reference area 700. Similarly, if the bottom-left region 716 is available, only a 4×4 luma block at bottom-right is included in the reference area 700. The reference area 700 can be adjusted accordingly based on the chroma color format. In another example, the top region 710 may always be 1-sample wide for both luma and chroma while the left region 714 may be 4-sample wide for luma.

FIG. 8 illustrates an example of a neighborhood 800 of a luma sample 802 used to predict a chroma sample. The neighborhood 800 illustrates a 3×3 neighborhood by example. In some cases, the neighborhood 800 can be larger or smaller than 3×3 and/or the neighborhood 800 can be a shape other than a square, such as a non-square rectangular or a diamond. The luma sample 802 is located within the middle of the neighborhood 800. The luma sample 802, which is labeled C to indicate it is the current luma sample under processing, is surrounded by neighboring luma samples 804, 806, 808, and 810, which will be used to predict a chroma sample for the luma sample 802. In the example shown, the luma samples 804, 806, 808, and 810 are respectively labeled using directional names N, S, E, and W (i.e., north, south, east, and west) relative to a location of the luma sample 802. Together, the luma sample 802 and the neighboring luma samples 804, 806, 808, and 810 comprise the values of the five-tap spatial component used in CCCM prediction, and which are used to calculate the predicted chroma sample for the luma sample 802, represented as predChroma Val=c₀C+c₁N+c₂S+c₃E+c₄W+c₅P+c₆B, in which the filter coefficients cᵢ may be derived using one or more simplification approaches as disclosed herein.

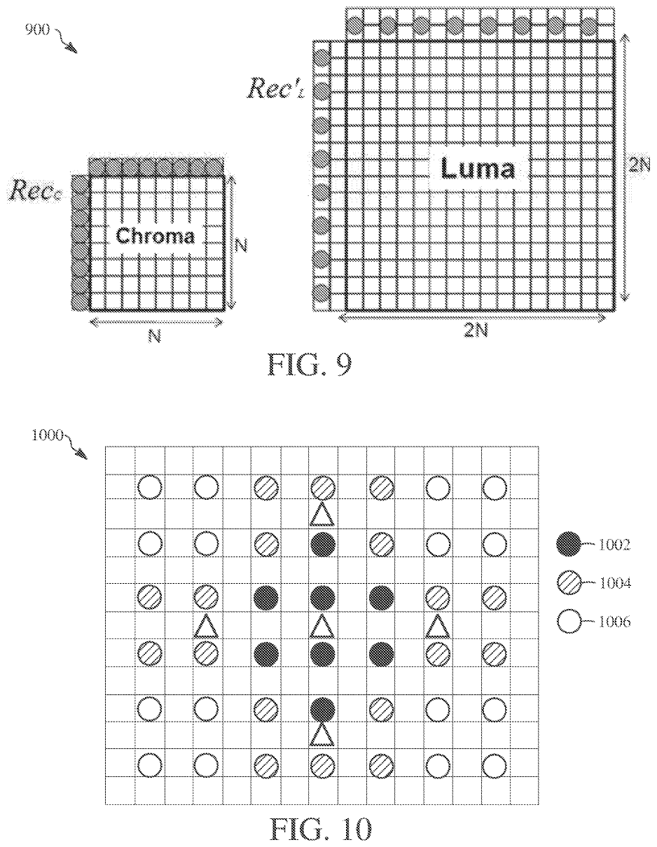

FIG. 9 illustrates example resolutions of luma and chroma blocks. As described above, and to ensure that appropriate luma samples are used to predict chroma samples for a given CU 900, it may be desirable to downsample (i.e., decrease a resolution of) the luma block for the CU under processing so that the resulting resolution of that luma block is the same as a resolution of the chroma blocks for the CU. For example, downsampling may be performed where the resolutions of the luma and chroma blocks are initially provided in a format such as 4:2:0. However, where the resolutions of the luma and chroma blocks for a given CU are already the same (e.g., 4:4:4), downsampling operations may be skipped for the CU.

FIG. 10 illustrates an example reference area 1000 used for deriving cross-component prediction filter coefficients directly from non-downsampled luma samples. As shown in FIG. 10, Type-0 chroma locations in 4:2:0 format are used, triangles represent chroma samples, and circles represent luma samples, in which certain of those luma samples are filled with solid patterns or colors. The luma samples filled with the solid color 1002 (black) correspond to luma samples surrounding a middle chroma sample to be predicted and thus which may be used for predicting that middle chroma sample. The luma samples filled with the pattern 1004, together with the luma samples filled with the solid color 1002, comprise a region of the reference area 1000 that may be used for a current CU under processing. The luma samples with the solid color 1006 (white) correspond to a padded region for the reference area 1000. In that the luma and chroma components are formatted in 4:2:0, the blocks thereof are not identically sized.

Typical CCCM prediction processes require downsampling of the luma component (e.g., to result in a 4:4:4 formatting) and the subsequent use of a filter against downsampled luma samples to derive filter coefficients, as two separate operations. However, the implementations of this disclosure enable the filter coefficients to be derived directly from the non-downsampled luma samples and thus without downsampling same by combining the operations which would otherwise be performed as part of downsampling and filter application into a single operation. In particular, and because downsampling may be thought of as a type of filtering itself, the calculations used to change resolutions of the luma samples are integrated with the calculations used for the filter applied against the luma samples. Using the reference area 1000 by example, the luma samples filled with the solid color 1002 may be used to predict the middle chroma sample, as described above, based on an identification of those luma samples resulting from the combined operations without downsampling.

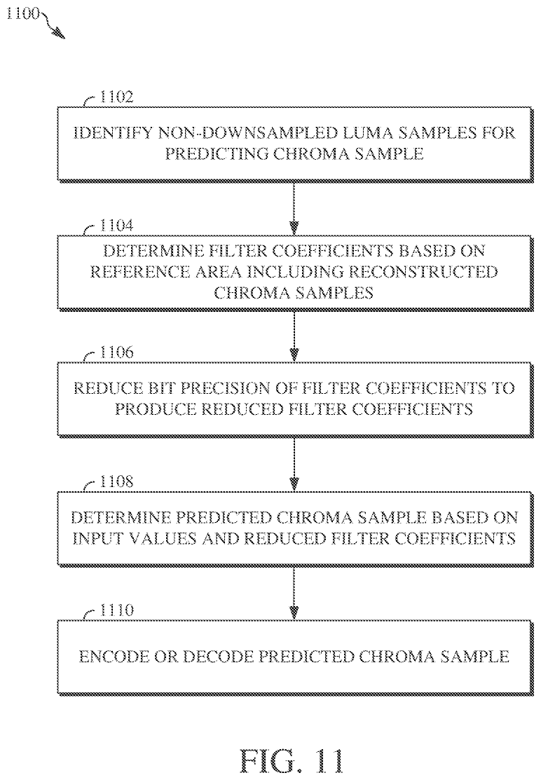

Further details of techniques for filter coefficient derivation simplification for cross-component prediction are now described. FIG. 11 is a flowchart diagram of an example of a technique 1100 for filter coefficient derivation simplification for cross-component prediction. The technique 1100 may, for example, be wholly or partially performed at a prediction stage of an encoder used to encode a video stream (e.g., the intra/inter prediction stage 402) or a prediction stage of a decoder used to decode a bitstream (e.g., the intra/inter prediction stage 508).

The technique 1100 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 1100. The technique 1100 can be implemented using specialized hardware or firmware. For example, a hardware component, such as a hardware coder, may be configured to perform the technique 1100. As explained above, some computing devices may have multiple memories or processors, and the operations described in the technique 1100 can be distributed using multiple processors, memories, or both. For simplicity of explanation, the technique 1100 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1102, luma samples are identified for predicting a chroma sample. The luma samples may be in an original format and thus non-downsampled, for example, as described above with respect to FIG. 10. Alternatively, the luma values may be downsampled, for example, as described above with respect to FIG. 9.

At 1104, filter coefficients are determined for CU in which the luma samples are located. The filter coefficients are CCCM prediction filter coefficients (i.e., the filter coefficients cᵢ). Determining the filter coefficients may include deriving the filter coefficients based on one or more previously coded and spatially neighboring regions, identifying the filter coefficients using one or more syntax elements signaled within a bitstream, or both.

Deriving the filter coefficients includes minimizing a MSE between the predicted and reconstructed chroma samples in a reference area, for example, the reference area 700 shown in FIG. 7 or the reference area 1000 shown in FIG. 10. During encoding, the filter coefficients are derived; however, during decoding, the filter coefficients may be derived and/or signaled. For example, signaling the filter coefficients may include explicitly or implicitly signaling the filter coefficients within the bitstream, such as within an adaptation parameter set, a slice header, a frame header, a block header, or another structure available for storing syntax elements for use in decoding encoded video data from a bitstream. In some cases, some, but not all of the filter coefficients for the CU may be signaled. In such a case, the remaining filter coefficients may be derived, as described above. For example, in such a case, a first subset of the filter coefficients may be signaled and a second subset of the filter coefficients may be derived.

In some implementations, filter coefficients may not be determined for some CUs. For example, filter coefficients may not be determined for CUs which are smaller than a threshold size (e.g., 8×8). In such a case, where a current CU is smaller than the threshold size, the technique 1100 may end without further processing the CU using CCCM prediction. In some such implementations, the threshold size check against the current CU may be performed before the luma samples are identified, as described above. In some implementations, rather than skip CCCM prediction altogether for a CU which is smaller than the threshold size, a smaller number of filter coefficients cᵢ may be used instead of the seven as otherwise disclosed herein. For example, in such a case, three filter coefficients may be used in which a first filter coefficient corresponds to a current position within the CU, a second filter coefficient corresponds to a square of the current position within the CU, and a third filter coefficient corresponds to a bias term (e.g., the bias term B, as described above).

At 1106, the bit precision of the filter coefficients is reduced to produce reduced filter coefficients. Reducing the bit precision of the filter coefficients includes reducing a number of bits used to store the values of the filter coefficients from a first number of bits (e.g., 22 bits) to a second number of bits (e.g., 6 or 8 bits). In some cases, reducing the bit precision of the filter coefficients includes right shifting the filter coefficients by a certain bit amount, such as 14 bits or 16 bits, after the filter coefficients are derived with their initial bit precision (e.g., 22 bit accuracy). In such a case, before the shift occurs, an offset may be added based on the shifted bit number to achieve a rounding effect. In some cases, rather than reducing the bit precision of the filter coefficients, a reduced bit precision can be determined and used to derive the filter coefficients in the manner described above. However, while doing so may result in more significant savings on processing costs, it would also likely result in a decrease in accuracy.

In some implementations, the value of the reduced filter coefficients may be further clipped using one or more threshold values to ensure that a dynamic range used for the filter coefficients remains within a desired quality range. For example, the one or more threshold values can include a maximum clipping value and a minimum clipping value. In the event a reduced filter coefficient is below the minimum clipping value, the reduced filter coefficient may be rounded up to that minimum clipping value. Similarly, in the event a reduced filter coefficient is above the maximum clipping value, the reduced filter coefficient may be rounded down to that maximum clipping value.

In some implementations, when deriving the filter coefficients, the filter coefficient corresponding to the DC value of the prediction (i.e., the bias term represented as B herein) may be derived after all other filter coefficients have been derived. That is, given that the calculation of that filter coefficient only requires some shift in that the bias term is a power of two, the constraint on the dynamic range described above may not be applied to the derivation of that filter coefficient.

At 1108, a predicted chroma sample is determined based on input values for cross-component (e.g., CCCM) prediction and the reduced filter coefficients. The input values are determined for a current luma sample to use for predicting the predicted chroma sample. The input values include the current luma sample, a number of neighboring luma samples of the current luma sample, and a bit precision of the video data being encoded or decoded. For example, the input values may correspond to the seven taps of the seven-tap filter used for CCCM prediction, which include the current luma sample C, four neighboring luma samples N, S, E, and W, a non-linear term, P, represented as a power of two of C and scaled to the sample value range of the content based on the bit precision (e.g., represented as P=(C*C +midVal)>>bitDepth, in which bitDepth represents the bit precision for the video content and midVal is the middle chroma value within that bit precision), and a bias term, B, represented as a scalar offset between the input and output, similar to the offset term in CCLM prediction, and set to the middle chroma value for the bit precision. The predicted chroma sample, represented as predChroma Val, may accordingly be determined by calculating predChroma Val=c₀C+c₁N+c₂S+c₃E+c₄W+c₅P+c₆B, in which C, N, S, E, W, P, and B are the input values for the current luma sample and c₀, c₁, c₂, c₃, c₄, c₅, and c₆ are the reduced filter coefficients.

The current luma sample and the number of neighboring luma samples are identified using a filter. In one example, the filter may apply against a 3×3 neighborhood within a CU that includes the current luma sample, as shown in FIG. 8. The filter may have a plus shape as is used with the example of FIG. 8, such that the number of neighboring luma samples includes four neighboring luma samples labeled N, S, E, and W as shown in FIG. 8; however, other examples of shapes may be used, and other sizes of neighborhoods may be used. For example, an x shape filter may be used in a 3×3 neighborhood, a diamond shape may be used in a 5×5 neighborhood, and so on. In some implementations, filters with a number of coefficients below a threshold may be used for CUs below a specified size (e.g., 8×8) and/or filters with a number of coefficients above the threshold may be used for CUs above that specified size.

In some implementations, to improve the prediction accuracy, adaptive clipping may be performed based on the chroma values in the reference area after the predicted chroma sample is determined. For example, maximum and minimum reconstructed chroma values in the reference area may be obtained. A valid range based on those maximum and minimum values may then be determined. Once the predicted chroma sample is determined, it may be clipped based on that valid range so that the predicted chroma sample remains within that valid range. For example, where the maximum and minimum values are expressed as C_min and C_max, the valid range may be represented as [C_min*(1-w), C_max*(1+w)], where the weighting factor w is either predefined or signaled in a bitstream.

In some implementations, where the auto-correlation matrix computed as part of the filter coefficient derivation process is singular, the average of the reconstructed chroma values in the reference area may be used as the predicted chroma sample.

At 1110, the predicted chroma sample is encoded (e.g., to a bitstream) or decoded (e.g., for output within an output video stream), based on whether the technique 1100 is performed during encoding or decoding. In some implementations, the predicted chroma sample may be reconstructed for us in predicting one or more other chroma samples in the region (e.g., within the same CU or PU in which the current luma sample is located and to which the predicted chroma sample corresponds).

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof.

That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500, or another encoder or decoder as disclosed herein) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102 can encode content into an encoded video signal and transmit the encoded video signal to the communications device. In turn, the communications device can then decode the encoded video signal. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

1. A method for filter coefficient derivation simplification for cross-component prediction, the method comprising:
determining filter coefficients for a current coding unit based on samples within a reference area for the current coding unit;
reducing a bit precision of the filter coefficients to produce reduced filter coefficients;
determining a predicted chroma sample for a current luma sample based on input values for the current luma sample and based on the reduced filter coefficients; and
encoding or decoding the predicted chroma sample.

2. The method of claim 1, wherein reducing the bit precision of the filter coefficients to produce the reduced filter coefficients comprises:
reducing a number of bits used to store values of the filter coefficients from a first number of bits to a second number of bits, wherein values of the reduced filter coefficients are stored using the second number of bits.

3. The method of claim 2, wherein the values of the reduced filter coefficients are clipped using one or more threshold values.

4. The method of claim 3, comprising:
clipping the reduced filter coefficients according to a minimum clipping value and a maximum clipping value.

5. The method of claim 1, wherein a filter coefficient corresponding to a bias term is determined after all other filter coefficients are determined.

6. The method of claim 1, wherein the filter coefficients are determined based on non-downsampled luma samples of the reference area.

7. The method of claim 1, wherein the filter coefficients are determined based on the current coding unit having a size greater than a threshold.

8. The method of claim 1, wherein a number of the filter coefficients is limited when a size of the current coding unit is less than a threshold.

9. The method of claim 7, wherein the threshold corresponds to an 8×8 chroma sample unit.

10. The method of claim 1, wherein a first number of the filter coefficients is determined based on the current coding unit having a size greater than a threshold and a second number of the filter coefficients smaller than the first number is determined based on the current coding unit having a size lesser than the threshold.

11. The method of claim 1, wherein determining the filter coefficients comprises:
deriving at least a portion of the filter coefficients based on reconstructed chroma samples within the reference area.

12. The method of claim 1, wherein determining the filter coefficients comprises:
decoding one or more syntax elements associated with the filter coefficients signaled within a bitstream.

13. The method of claim 1, wherein the predicted chroma sample is clipped using one or more threshold values and based on chroma values in the reference area.

14. The method of claim 13, comprising:
clipping the predicted chroma sample according to a minimum clipping value, a maximum clipping value, and a weighting factor.

15. An apparatus for filter coefficient derivation simplification for cross-component prediction, the apparatus comprising:
a processor configured to:
obtain samples within a reference area for a current coding unit;
reduce a bit precision of filter coefficients determined based on the samples to produce reduced filter coefficients;
determine input values for a current luma sample;
determine a predicted chroma sample for the current luma sample based on the input values and the reduced filter coefficients; and
encode or decode the predicted chroma sample.

16. The apparatus of claim 15, wherein the processor is configured to:
clip the reduced filter coefficients according to a minimum clipping value and a maximum clipping value.

17. The apparatus of claim 15, wherein the processor is configured to:
clip the predicted chroma sample based on chroma values in the reference area.

18. The apparatus of claim 15, wherein, when an auto-correlation matrix computed in connection with the determination of the filter coefficients is singular, an average of reconstructed chroma values in the reference area is used as the predicted chroma sample.

19. A non-transitory computer-readable storage device including program instructions executable by one or more processors that, when executed, cause the one or more processors to perform operations for filter coefficient derivation simplification for cross-component prediction, the operations comprising:
reducing a bit precision of filter coefficients determined for a current coding unit to produce reduced filter coefficients;
determining input values for a current luma sample;
determining a predicted chroma sample for the current luma sample based on the input values and the reduced filter coefficients; and
encoding or decoding the predicted chroma sample.

20. The non-transitory computer-readable storage device of claim 19, wherein the reduced filter coefficients are clipped according to a minimum value and a maximum value, and wherein the predicted chroma sample is clipped based on chroma values in a reference area that includes samples used to determine the filter coefficients.
